(19) United States
(12) Patent Application Publication
(10) Pub. No.: US 2013/0083579 A1
(43) Pub. Date: Apr. 4, 2013

(54) PRE-BIASED SAMPLING FILTER

(71) Applicants: Yury Gaknoki, San Jose, CA (US); Arthur B. Odell, Morgan Hill, CA (US)

(72) Inventors: Yury Gaknoki, San Jose, CA (US); Arthur B. Odell, Morgan Hill, CA (US)

(73) Assignee: Power Integrations, Inc., San Jose, CA (US)

(21) Appl. No.: 13/248,992

(22) Filed: Sep. 29, 2011

(51) Int. Cl. H02M 7/537; G05F 1/46

(52) U.S. Cl. 363/131; 327/541

(57) ABSTRACT

Methods and apparatuses are disclosed for sampling a feedback signal representative of an output of a power converter using a pre-biased filter capacitor. The pre-biased filter capacitor provides accurate sampling of the feedback signal during various load conditions. The pre-biased filter may be pre-charged to a pre-bias voltage that is below the regulated voltage of the feedback signal to reduce the amount of time required to charge the pre-biased filter capacitor to the regulated voltage of the feedback signal.

### BACKGROUND

1. Field

The present disclosure relates generally to power converters, and, more specifically, the present disclosure relates to controllers for power converters.

2. Related Art

Many electrical devices, such as cell phones, personal digital assistants (PDAs), laptops, and the like, are powered by relatively low-voltage, direct-current (dc) power sources. Since power is typically delivered through a wall outlet as high-voltage, alternating-current (ac) power, a device generally referred to as a switching-power converter may be used to transform the high-voltage ac power to low-voltage dc power. These converters typically use a controller to switch a power switch between an on state and an off state to control the amount of power delivered to the load at the output of the power converter.

In certain applications, switching-power converters may include an energy transfer element to separate an input side of the converter from an output side of the converter. More specifically, an energy transfer element may be used to provide galvanic isolation that prevents dc current between the input and the output of the power converter. Common examples of energy transfer elements include transformers and coupled inductors, where electrical energy is converted to magnetic energy that is then converted back to electrical energy at the output side of the converter across an output winding.

Typically, converters include circuitry for regulating the output of the power converter. One way of regulating the output, referred to as primary-side regulation, may include obtaining feedback information using a bias winding that is electrically coupled to the input side of the converter and also magnetically coupled to the output winding of the energy transfer element. This allows the bias winding to produce a voltage representative of the output voltage of the converter that is accessible from the input side. In this manner, the switching-power converter may acquire a feedback signal representative of the output voltage without directly sensing the output voltage at the output of the converter. During operation, the controller may regulate the output of the power converter by adjusting one or more parameters (e.g., duty ratio, switching frequency, the number of pulses per unit time of the switch, or the like) of the switching events in response to the feedback from the bias winding. By adjusting one or more parameters of the switching events, the converter may control the amount of energy transferred from an input of the converter to the output of the converter.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1A is an example voltage waveform illustrating the voltage of an unfiltered feedback signal and the voltage of a filtered feedback signal during a normal load condition in accordance with an embodiment of the present invention.

FIG. 1B is an example voltage waveform illustrating the voltage of an unfiltered feedback signal and the voltage of a filtered feedback signal during a light load condition in accordance with an embodiment of the present invention.

FIG. 2 is an example power converter including a controller having a pre-biased filter in accordance with an embodiment of the present invention.

FIG. 3A is an example voltage waveform illustrating the voltages of an unfiltered feedback signal, a filtered feedback signal, and a feedback signal filtered with a pre-biased filter during a light load condition in accordance with an embodiment of the present invention.

FIG. 3B is an example voltage waveform illustrating the voltages of a filtered feedback signal and a feedback signal filtered with a pre-biased filter during a normal load condition in accordance with an embodiment of the present invention.

FIG. 4 is a schematic illustrating an example controller having a pre-biased filter in accordance with an embodiment of the present invention.

FIG. 5 illustrates example voltage waveforms for various signals of the controller of FIG. 4 in accordance with an embodiment of the present invention.

FIG. 6 illustrates an example process for sampling a feedback signal using a pre-biased filter in accordance with an embodiment of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment,” “an embodiment,” “one example,” or “an example” means that a particular feature, structure or characteristic described in connection with the embodiment or example is included in at least one embodiment of the present invention. Thus, appearances of the phrases “in one embodiment,” “in an embodiment,” “one example,” or “an example” in various places throughout this specification are not necessarily all referring to the same embodiment or example. Furthermore, the particular features, structures, or characteristics may be combined in any suitable combinations and/or subcombinations in one or more embodiments or examples. Particular features, structures, or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

Generally, power converters using primary-side regulation, also known as primary-side sensing, may use the voltage across a bias winding to determine an output voltage. In one example, a bias winding voltage may be representative of the output voltage of the power converter for only a portion of the time after the switch has switched to the off state and while the output diode is conducting current.

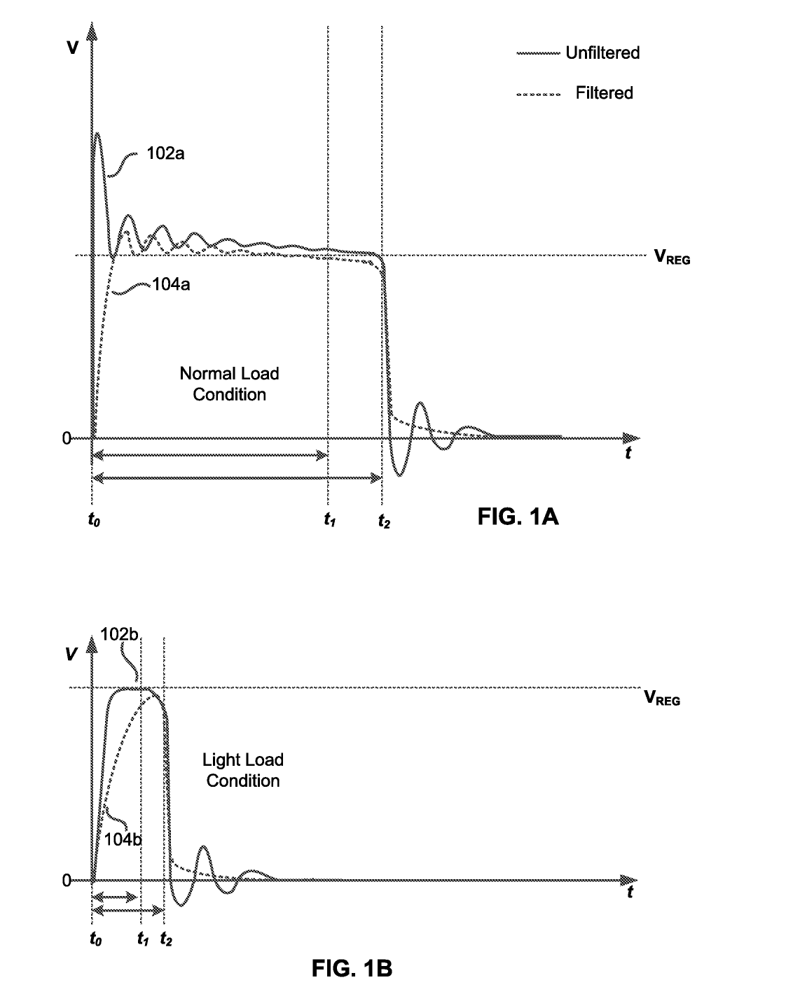

To illustrate, FIG. 1A shows an unfiltered feedback signal 102a of a power converter (represented by the solid line) and a filtered feedback signal 104a of the power converter (represented by the dotted line) during normal load conditions. As shown, the voltage of unfiltered feedback signal 102a experiences an initial spike and ripple shortly after the switch is switched to the off state at time t₀. The voltage of unfiltered feedback signal 102a becomes relatively stable after time t₁ before beginning to quickly drop at time t₂ when substantially all of the energy in the energy transfer element has been transferred to the output side of the power converter. Thus, unfiltered feedback signal 102a is typically sampled at time t₁ and the sampled voltage is provided to a controller of the power converter to be used for output regulation. However, due to the large amount of noise present in unfiltered feedback signal 102a, the voltage of the unfiltered feedback signal 102a may still fluctuate due to noise at time t₁, resulting in a sample that does not accurately reflect the regulated voltage V_{REG}, which represents the actual output voltage of the power converter. In some examples, the feedback signal (e.g., unfiltered feedback signal 102a and filtered feedback signal 102b) is generated from a bias winding. The voltage on the bias winding may have the same or a different voltage than the output voltage of the power converter depending on the turns ratio between the secondary winding and the bias winding. Additionally, the bias winding voltage may be scaled down using a resistor divider network. Thus, the bias winding voltage may be the same or different than the actual output voltage of the power converter. Regulated voltage V_{REG} may be the sampled voltage of the feedback signal that is representative of the actual output voltage. In other words, regulated voltage V_{REG} is the desired voltage to be sampled since it is most representative of the actual output voltage V_{OUT}. As shown in FIG. 1A, the noise in unfiltered feedback signal 102a causes a difference between the regulated voltage V_{REG} and the sampled voltage of unfiltered feedback signal 102a at time t₁.

To reduce the amount of noise in unfiltered feedback signal 102a, an RC filter including a resistor and a capacitor may be used to filter unfiltered feedback signal 102a. As shown in FIG. 1A, during normal load conditions, the filtered feedback signal 104a experiences a reduced amount of ripple and settles more quickly. This reduces the amount of fluctuation in filtered feedback signal 104a at time t₁, allowing for more accurate sample measurements. For example, as shown in FIG. 1A, the difference between the regulated voltage V_{REG} and the sampled voltage of the filtered feedback signal 104a at time t₁ is less than the difference between the regulated voltage V_{REG} and the sampled voltage of unfiltered feedback signal 102a at time t₁.

While the use of a filter capacitor may result in more accurate measurements during normal load conditions, there may be a drawback during light load conditions. To illustrate, FIG. 1B shows an unfiltered feedback signal 102b of a power converter (represented by the solid line) and a filtered feedback signal 104b of the power converter (represented by the dotted line) during light load conditions. As shown in FIG. 1B, the duration of t₂ (the time when the voltage of unfiltered feedback signal 102b begins to quickly drop to zero volts) is significantly reduced due to the reduced amount of power transferred to the output of the converter at light load conditions. Additionally, the unfiltered feedback signal 102b may not include an initial spike and ripple. Instead, unfiltered feedback signal 102b may gradually increase from zero volts at time t₀ until reaching the regulated voltage V_{REG}. At time t₁, unfiltered feedback signal 102b may be sampled and the sampled voltage may be provided to a controller of the power converter to be used for output regulation. As shown in FIG. 1B, the sampled voltage at time t₁ closely matches that of the regulated voltage V_{REG}.

However, when a filter capacitor is included, as discussed above, the voltage of the feedback signal may increase more slowly. The delayed increase in voltage (due to the filter capacitor) combined with the shortened duration of time t₂ (due to the light load condition) may prevent the voltage of filtered feedback signal 104b from reaching the regulated voltage V_{REG} before it is sampled at time t₁. As a result, the sampled voltage of filtered feedback signal 104b taken at time t₁ may not accurately reflect the regulated voltage V_{REG} that represents the actual output voltage of the power converter.

In embodiments of the present disclosure, a pre-biased filter is provided to allow accurate sampling of a filtered feedback signal during various load conditions. The pre-biased filter may be pre-biased, or pre-charged, to a predetermined voltage that is below the regulated voltage of the feedback signal to reduce the amount of time required to charge the pre-biased filter capacitor to the regulated voltage of the feedback signal.

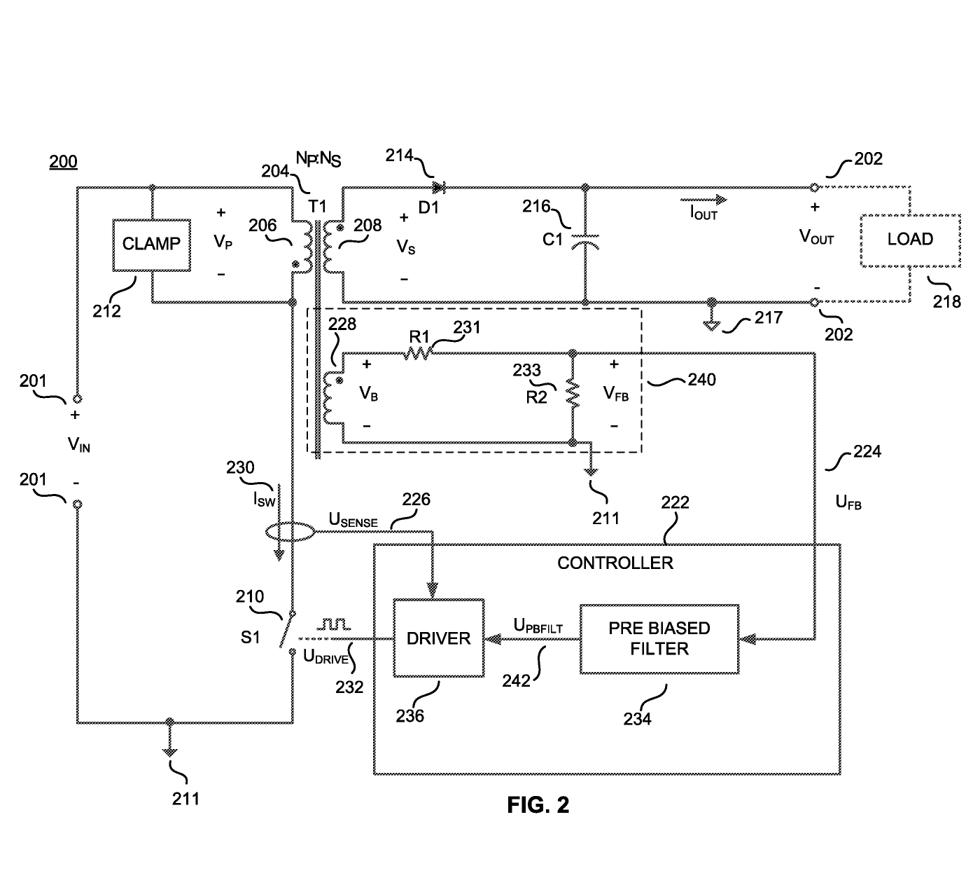

Referring to FIG. 2, a schematic of an example power converter 200 is illustrated. Power converter 200 includes input terminals 201 receiving a unregulated dc input voltage V_{IN}, an energy transfer element T1 204 having a primary winding 206, a secondary winding 208, and a bias winding 228, a power switch S1 210, a clamp circuit 212, a rectifier D1 214, an output capacitor C1 216, output terminals 202 coupled to a load 218, an output voltage V_{OUT}, an output current I_{OUT}, sense circuit 240, a controller 222, a feedback signal U_{FB} 224, a current sense input 226, a drive signal U_{DRIVE} 232, and a switch current I_{sw} 230. Controller 222 further includes a pre-biased filter circuit 234, a driver circuit 236, and a pre-biased filtered feedback signal U_{PBFILT} 242. In the illustrated example, the power converter 200 is shown as a power converter having a flyback topology for explanation purposes. It is appreciated that other known topologies and configurations of a power converter may also benefit from the teachings of the present disclosure.

In operation, the power converter 200 of FIG. 2 provides output power to the load 218 from unregulated input V_{IN}. The power converter 200 utilizes the energy transfer element T1 204 to transform the input voltage V_{IN} between the primary 206 and secondary 208 windings. Specifically, power switch S1 210 is opened and closed in response to the drive signal U_{DRIVE} 232 received from the controller 222 to control the amount of current conducted through the primary winding 206 of energy transfer element T1 204. It is generally understood that a switch that is closed may conduct current and is considered on, while a switch that is open cannot conduct current and is considered off. In the example of FIG. 2, power switch S1 210 controls a current I_{D} 230 in response to controller 222 to meet a specified performance of the power converter 200. In some embodiments, the power switch S1 210 may include a transistor and the controller 222 may include integrated circuits and/or discrete electrical components. In one embodiment, controller 222 and power switch S1 210 are included together in a single integrated circuit. In one example, the integrated circuit is a monolithic integrated circuit. In another example, the integrated circuit is a hybrid integrated circuit.

As shown, power converter 200 provides output power to load 218 from unregulated input voltage V_{IN}. In one embodiment, the input voltage V_{IN} is a rectified and filtered ac line voltage. As shown, input voltage V_{IN} is coupled to be received by energy transfer element T1 204. In some embodiments, energy transfer element T1 204 may include a coupled inductor. In other embodiments, the energy transfer element T1 204 may include a transformer. In the example of FIG. 2, the energy transfer element T1 204 includes three windings: a primary winding 206, a secondary winding 208, and a bias winding 228. N_{P} and N_{S} represent the number of turns for the primary winding 206 and secondary winding 208, respectively. In the example of FIG. 2, primary winding 206 may be considered an input winding and secondary winding 208 may be considered an output winding. The primary winding 206 is further coupled to the power switch S1 210, which is then further coupled to the input return 211. In addition, clamp circuit 212 is coupled across the primary winding 206 of the energy transfer element T1 204 to limit the maximum voltage on the power switch S1 210.

As shown, secondary winding 208 of the energy transfer element T1 204 is coupled to the rectifier D1 214. In the example illustrated in FIG. 2, the rectifier D1 214 includes a diode and the secondary winding 208 is coupled to the anode end of the diode. Both output capacitor C1 216 and load 218 are coupled to the rectifier D1 214 and are also coupled to the output return 217. Output return 217 may be coupled to input return 211 or may be electrically isolated from input return 211. In the example of FIG. 2, the rectifier D1 214 is exemplified as a diode and both the output capacitor C1 216 and the load 218 are coupled to the cathode end of the diode. An output is provided at output terminals 202 to the load 218 and may be provided as either a regulated output voltage V_{OUT}, regulated output current I_{OUT}, or a combination thereof.

In operation, the switching of power switch S1 210 produces a time varying voltage V_{P} between the ends of primary winding 206. By transformer action, a scaled replica V_{S} of the voltage V_{P} is produced between the ends of secondary winding 208, the scale factor being the ratio that is equal to the number of turns N_{S} of secondary winding 208 divided by the number of turns N_{P} of primary winding 206. The switching of power switch S1 210 also produces a pulsating current at the rectifier D1 214. The current in rectifier D1 214 is filtered by output capacitor C1 216 to produce a substantially constant output voltage V_{OUT}, output current I_{OUT}, or a combination thereof at the load 218.

Switched mode power converter 200 further includes sense circuit 240 to provide feedback information to controller 222 for regulating the output voltage V_{OUT}, output current I_{OUT}, or a combination thereof. In one example, bias winding 228 is adapted to provide a bias winding voltage that is representative of the output voltage when power switch 210 is in a first state and representative of the input voltage when power switch 210 is a second state. As shown, bias winding 228 is adapted to provide of sending feedback signal U_{FB} 224 to controller 222, which allows indirect sensing of the input voltage V_{IN} and the output voltage V_{OUT} from the input side of the power converter 200. Sense circuit 240 further includes resistors R1 231 and R2 233 for scaling bias winding voltage V_{B} to generate feedback signal U_{FB} 224.

In operation, controller 222 is coupled to switch power switch 210 S1 between an on state and an off state to regulate an output quantity at output terminals 235. During the time power switch S1 210 is in the on state (also referred to as the on time), bias winding 228 produces a bias winding voltage V_{B} that is representative of the input voltage V_{IN}. During the time power switch S1 210 is in the off state (also referred to as the off time), bias winding voltage V_{B} may be representative of output voltage V_{OUT}. In accordance with the flyback topology as shown in FIG. 2, due to the magnetic coupling in energy transfer element T1 204, energy is delivered to output winding 208 and to bias winding 228 when power switch 210 is in an off state. The magnetic coupling further causes bias winding voltage V_{B} induced across bias winding 228 to be substantially proportional to secondary voltage V_{S} across secondary winding 208.

As shown, controller 222 is further coupled to sense circuit 240 and may include multiple inputs. It should be appreciated that in one example, inputs may be physical terminals on controller 222. At one input, controller 222 receives feedback signal U_{FB} 224 from the sense circuit 240. Controller 222 furthermay include terminals for receiving the current sense input 226 and outputting the drive signal U_{DRIVE} 232. The current sense input 226 provides information associated with the sensed switch current I_{D} 230 in power switch S1 210. The switch current I_{D} 230 may be sensed in a variety of ways, such as, for example, the voltage across a discrete resistor or the voltage across the transistor when the transistor is conducting. In addition, the controller 222 provides the drive signal U_{DRIVE} 232 to the power switch S1 210 and may implement various switching schemes such as, but not limited to, pulse width modulation (PWM), ON/OFF control, variable switching frequency, and the like.

As illustrated in FIG. 2, controller 222 includes pre-biased filter circuit 234, driver circuit 236, and pre-biased filtered feedback signal U_{PBFILTFB} 242. The pre-biased filter circuit 234 is coupled to receive the feedback signal U_{FB} 224 from sense circuit 240. The pre-biased filter circuit 234 outputs the pre-biased filtered feedback signal U_{PBFILTFB} 242. The output of the pre-biased filter circuit 234 (pre-biased filtered feedback signal U_{PBFILTFB} 242) is coupled to and received by the driver circuit 236. Driver circuit 236 outputs drive signal U_{DRIVE} 232 in response to pre-biased filtered feedback signal U_{PBFILTFB} 242. Driver circuit 236 further receives current sense signal 226. In some examples, driver circuit 236 may use current sense signal 226 to generate drive signal U_{DRIVE} 232, while in other examples, current sense signal 226 may be used to limit the amount of current conducted through the power switch of the power converter.

The controller 222 outputs drive signal U_{DRIVE} 232 to operate the power switch S1 210 in response to various system inputs to substantially regulate the output voltage V_{OUT}, output current I_{OUT}, or a combination thereof, to the desired value. With the use of sense circuit 240 and controller 222, power converter 200 implements closed loop regulation to regulate the output quantity at output terminals 202.

As will be discussed in greater detail below, pre-biased filter circuit 234 converts feedback signal U_{FB} 224 to a pre-biased filtered feedback signal U_{PBFILTFB} 242. The pre-biased filter circuit 234 includes a pre-biased filter capacitor that may be charged to a pre-bias voltage that is below the regulated voltage of the feedback signal U_{FB} 224 to reduce the amount of time required to charge a conventional (unbiased) capacitor to the regulated voltage of the feedback signal U_{FB}224. Pre-biased filtered feedback signal U_{PBFILTFB} 242 is utilized by the driver circuit 236 to regulate the output of power converter 200 by controlling the operation of power switch S1 210.

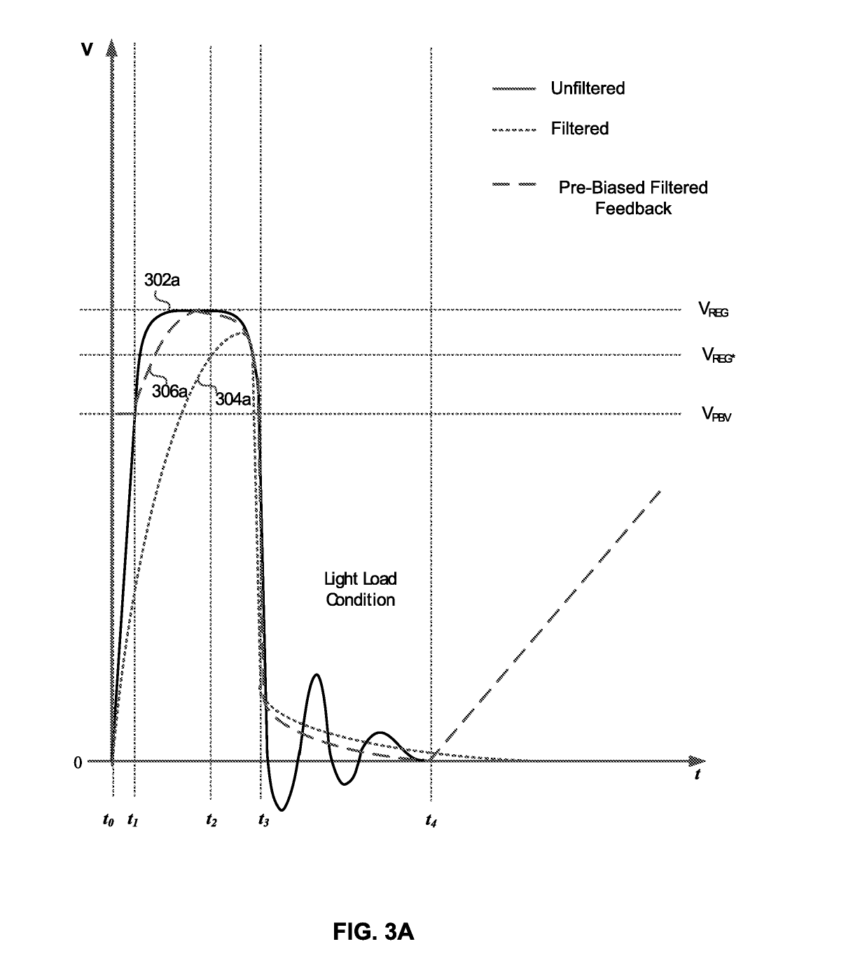

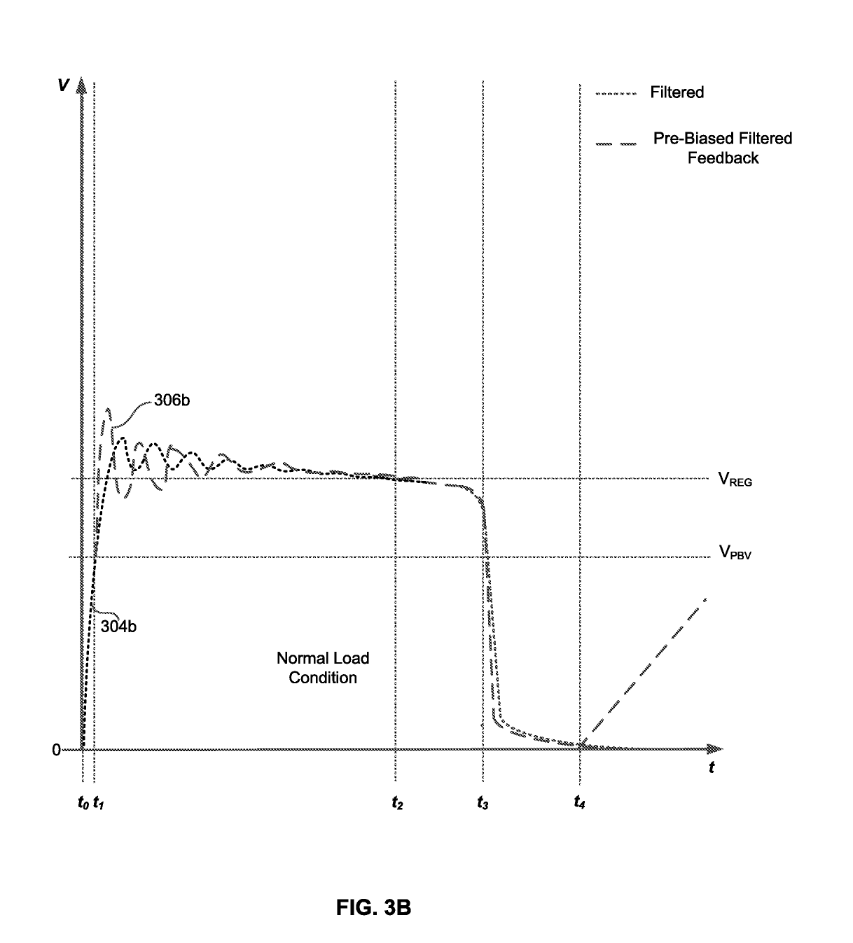

FIG. 3A illustrates an example waveform of an unfiltered feedback signal 302a (represented by the solid line), a filtered feedback signal 304a (represented by the dotted line), and a pre-biased filtered feedback signal 306a (represented by the dashed line) filtered by a pre-biased filter during light load conditions. In one example, unfiltered feedback signal 302a may be representative of feedback signal U_{FB} 224. In another example, pre-biased filtered feedback signal 306a may be representative of pre-biased filtered feedback signal U_{PBFILTFB} 242. Similar to FIG. 1B, FIG. 3A shows the voltage of unfiltered feedback signal 302a (represented by the solid line) starting at zero volts at time t₀ and increasing to a regulated voltage V_{REG} representative of output voltage V_{OUT} before being sampled at time t₂. In one example, regulated voltage V_{REG} is determined from feedback voltage V_{FB}. Specifically, feedback voltage V_{FB} is generated from bias winding 228 and may have the same or a different voltage than the output voltage V_{OUT} depending on the turns ratio between the secondary winding 208 and the bias winding 228. Additionally, the bias winding voltage V_{B} may be scaled down using a resistor divider network formed by resistors R1 231 and R2 233. Thus, feedback voltage U_{FB} may be the same or different than the actual output voltage V_{OUT} of power converter 200. Regulated voltage V_{REG} may be the voltage that is sampled when feedback voltage V_{FB} is representative of the output voltage V_{OUT}. In other words, regulated voltage V_{REG} is the desired voltage to be sampled since it is most representative of the actual output voltage V_{OUT}. At time t₃, unfiltered feedback signal 302a begins to quickly drop to zero volts.

Additionally, similar to FIG. 1B, FIG. 3A shows the voltage of filtered feedback signal 304a (represented by the dotted line) starting at zero volts and increasing at a rate slower than that of the voltage of the unfiltered feedback signal 302a. As a result, if filtered feedback signal 304a is sampled at time t₂, a sample is obtained having a voltage V_{REG*} that is less than the regulated voltage V_{REG}, which is representative of the actual output voltage V_{OUT}. In other words, when filtered feedback signal 304a is to be sampled, the voltage of filtered feedback signal 304a may not have had enough time to reach regulated voltage V_{REG}, resulting in a sampled voltage that is representative of an output voltage less than the actual output voltage V_{OUT}. It is appreciated that filtered feedback signal 304a is shown to illustrate the differences between a filtered feedback signal 304a and pre-biased, or pre-charged, filtered feedback signal 306a. In one example, power converter 200 may not produce filtered feedback signal 304a but only a pre-biased feedback signal 306a.

However, if a pre-biased filter is used, the voltage of the pre-biased filter (voltage of pre-biased filtered feedback signal 306a) begins at a pre-bias voltage of V_{PBV} and increases until reaching regulated voltage V_{REG}. Specifically, at time t₁ (corresponding to the time that the feedback V_{FB} reaches V_{PBV}), the pre-biased filter begins to charge, causing the voltage of pre-biased filtered feedback signal 306a to begin increasing. Since the pre-biased filter voltage 306a starts at a value V_{PBV} that is greater than the voltage of filtered feedback signal 304a at time t₁, the amount of time required to charge the pre-biased filter from the pre-bias voltage V_{PBV} to the regulated voltage V_{REG} is less than the time required to charge the unbiased filter from the voltage of filtered feedback signal 304a at time t₁ to the regulated voltage V_{REG}. Thus, by using a pre-biased filter, the amount of time required for the filtered feedback signal to reach the regulated voltage V_{REG} is decreased, thereby providing a more accurate sample at time t₂. At time t₃, the voltage of pre-biased filtered feedback signal 306a begins to quickly drop to zero volts and at time t₄, the pre-biased filter may begin to be charged back up to the pre-bias voltage V_{PBV} before filtering the feedback signal during the next switching cycle.

FIG. 3B illustrates an example waveform of a filtered feedback signal 304b (represented by the dotted line) and a pre-biased filtered feedback signal 306b (represented by the dashed line) filtered by a pre-biased filter during normal load conditions. In one example, pre-biased filtered feedback signal 306b may be representative of pre-biased filtered feedback signal U_{PBFILTFB} 242. Similar to FIG. 1A, FIG. 3b shows the voltage of filtered feedback signal 304b (represented by the dotted line) experiencing an initial spike and ripple shortly after the switch is switched to the off state at time t₀. The voltage of filtered feedback signal 304b becomes relatively stable before being sampled at time t₂, producing a sample having a voltage at or close to the regulated voltage V_{REG}. At time to t₃, the voltage of filtered feedback signal 304b begins to quickly drop to zero volts. It is appreciated that filtered feedback signal 304b is shown to illustrate the differences between a filtered feedback signal 304b and pre-biased, or pre-charged, filtered feedback signal 306b. In one example, power converter 200 may not produce filtered feedback signal 304b but only a pre-biased feedback signal 306b.

As shown in FIG. 3B, if a pre-biased filter is used, the voltage of the pre-biased filter (voltage of pre-biased filtered feedback signal 306b) begins at a pre-bias voltage of V_{PBV} and experiences an initial spike and ripple similar to filtered feedback signal 304b. However, the initial spike and ripple of pre-biased filtered feedback signal 306b begins at time t₁ (corresponding to the time that the feedback voltage reaches V_{PBV}) rather than at time t₀ as is the case for filtered feedback signal 304b. Additionally, while the initial spike and ripple of pre-biased filtered feedback signal 306b are slightly larger than those of filtered feedback signal 304b, the voltage of pre-biased filtered feedback signal 306b settles to the regulated voltage V_{REG} before being sampled at time t₂. Thus, there is little to no impact on the sampled voltage of the pre-biased filtered feedback signal 306b during normal load conditions. At time t₃, pre-biased filtered feedback signal 306b begins to quickly drop to zero volts and at time t₄, the pre-biased filter may begin to be charged back up to the pre-bias voltage V_{PBV} before filtering the feedback signal during the next switching cycle.

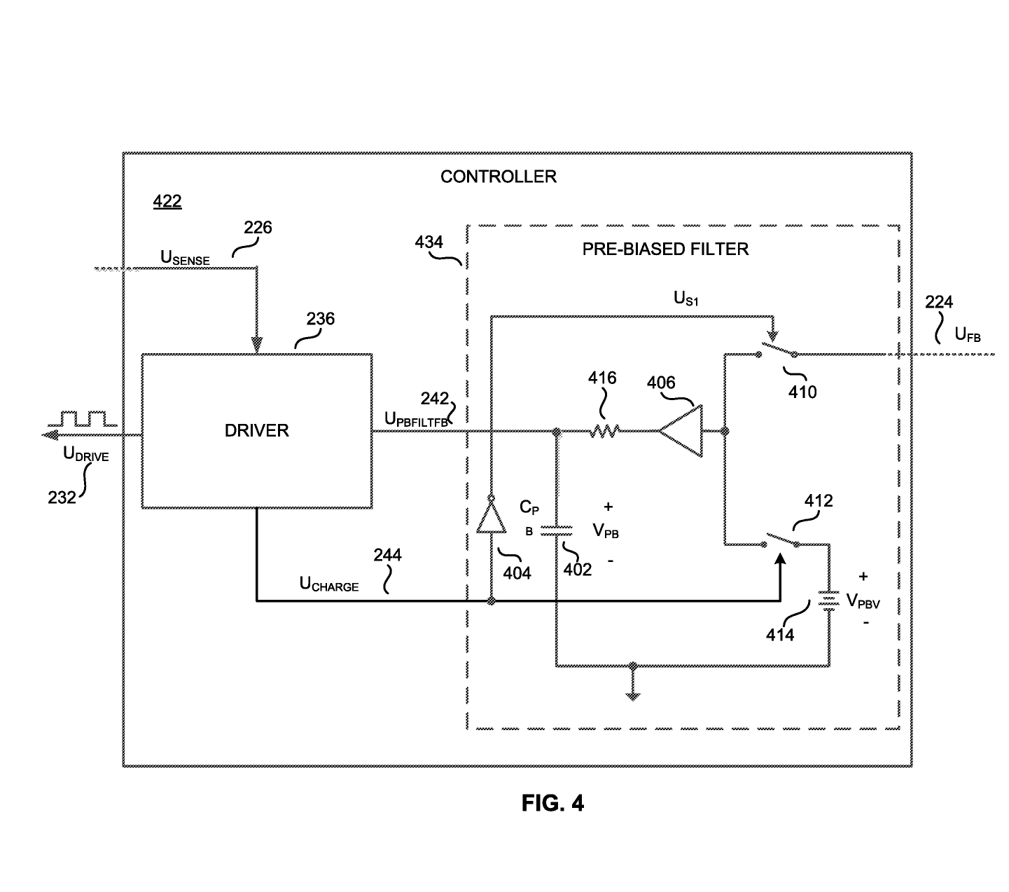

FIG. 4 illustrates a schematic of an example controller 422 for use in a power converter similar or identical to power converter 200 shown in FIG. 2. Controller 422 is an example of a controller that can be used as controller 222 in power converter 200. Controller 422 includes pre-biased filter circuit 434, which is an example of pre-biased filter circuit 234 of controller 222, for receiving feedback signal U_{FB} and generating a pre-biased filtered feedback signal U_{PBFILTFB} 242. The pre-biased filtered feedback signal U_{PBFILTFB} 242 is provided to a driver circuit 236. Driver circuit 236 also receives current sense signal 226 and may generate drive signal U_{DRIVE} 232 based at least in part on the pre-biased filtered feedback signal U_{PBFILTFB} 242. In some examples, driver circuit 236 may also generate drive signal U_{DRIVE} 232 based at least in part on current sense signal 226, while in other examples, driver circuit 236 may use current sense signal 226 to limit the amount of current conducted through the power switch of the power converter. Driver circuit 236 further generates a charge signal U_{CHARGE} 244 for controlling the biasing of a pre-biased capacitor C_{PB} 402 in pre-biased filter circuit 434.

In operation, pre-biased filter capacitor C_{PB} 402 is used for filtering feedback signal U_{FB} 224. The voltage V_{PB} across pre-biased filter capacitor C_{PB} 402 is provided to driver circuit 236 through resistor 416 as pre-biased filtered feedback signal U_{PBFILTFB} 242. Pre-biased filter circuit 434 further includes switches 410 and 412 coupled to feedback signal U_{FB} 224 and pre-biased voltage source 414, respectively. Switches 410 and 412 selectively couple feedback signal U_{FB} 224 and pre-biased voltage source 414 to buffer 406 to charge pre-biased filter capacitor C_{PB} 402. Pre-biased filter circuit 434 further includes inverter 404 coupled to switch 410. Inverter 404 inverts the charge signal U_{CHARGE} 244 received from driver circuit 236 and provides the inverted signal to switch 410.

In operation, driver circuit 236 generates a charge signal U_{CHARGE} 244 to control switches 410 and 412 of pre-biased filter circuit 434. When charge signal U_{CHARGE} 244 is set to a first voltage level (e.g., a high voltage), switch 412 may be switched to an on state, allowing the switch to conduct current, thereby causing pre-biased voltage source 414 to pre-charge pre-biased filter capacitor C_{PB} 402 to pre-bias voltage V_{PBV}. Inverter 404 inverts the first voltage level of charge signal U_{CHARGE} 244 to a second voltage level (e.g., a low voltage) and provides the inverted signal to switch 410. The inverted charge signal U_{S1} causes switch 410 to switch to an off state. This uncouples the feedback signal U_{FB} 224 from pre-biased filter capacitor C_{PB} 402, preventing the feedback signal U_{FB} 224 from charging the pre-biased filter capacitor C_{PB} 402.

When charge signal U_{CHARGE} 244 is set to the second voltage level (e.g., a low voltage), switch 412 may be switched to an off state, preventing switch 412 from substantially conducting current. This uncouples the pre-biased voltage source 414 from pre-biased filter capacitor C_{PB} 402, preventing the pre-biased voltage source 414 from charging the pre-biased filter capacitor C_{PB} 402. Inverter 404 inverts the second voltage level of charge signal U_{CHARGE} 244 to the first voltage level (e.g., a high voltage) and provides the inverted signal to time delay circuit 408. The delayed and inverted charge signal is then provided to switch 410, causing the switch to switch to an on state, allowing the switch to conduct current, thereby causing feedback signal U_{FB} 224 to charge pre-biased filter capacitor C_{PB} 402 to a voltage representative of the output voltage V_{OUT}.

As mentioned above, the pre-bias voltage V_{PBV} may be selected to be less than the internal voltage designed for the controller to regulate too. For example, if controller 422 attempts to regulate the feedback terminal or voltage at 2V, the voltage of pre-bias voltage V_{PBV} may be selected to be 1.5 V. While a specific example is provided, it should be appreciated that other values may be selected in response to, but not limited to, the regulated voltage of feedback signal U_{FB} 224, the rate that pre-biased filter capacitor C_{PB} 402 charges, the switching frequency of drive signal U_{DRIVE} 232 during light load conditions. According to the teachings of the present invention pre biasing the sample capacitor and filtering the feedback signal may accomplish a substantially noise free feedback signal U_{FB} at the time of sampling under normal load conditions while maintaining the integrity of the feedback signal under light load conditions.

Driver circuit 236 may generate charge signal U_{CHARGE} 244 based on the drive signal U_{DRIVE} 232. For instance, in some examples, driver circuit 236 may configure charge signal U_{CHARGE} 244 to cause switch 412 to switch to an on state during at least a portion of the time that drive signal U_{DRIVE} 232 is low. In other examples, driver circuit 236 may configure charge signal U_{CHARGE} 244 to cause switch 412 to switch to an on state during at least a portion of the time that drive signal U_{DRIVE} 232 is high and at least a portion of the time that drive signal U_{DRIVE} 232 is low.

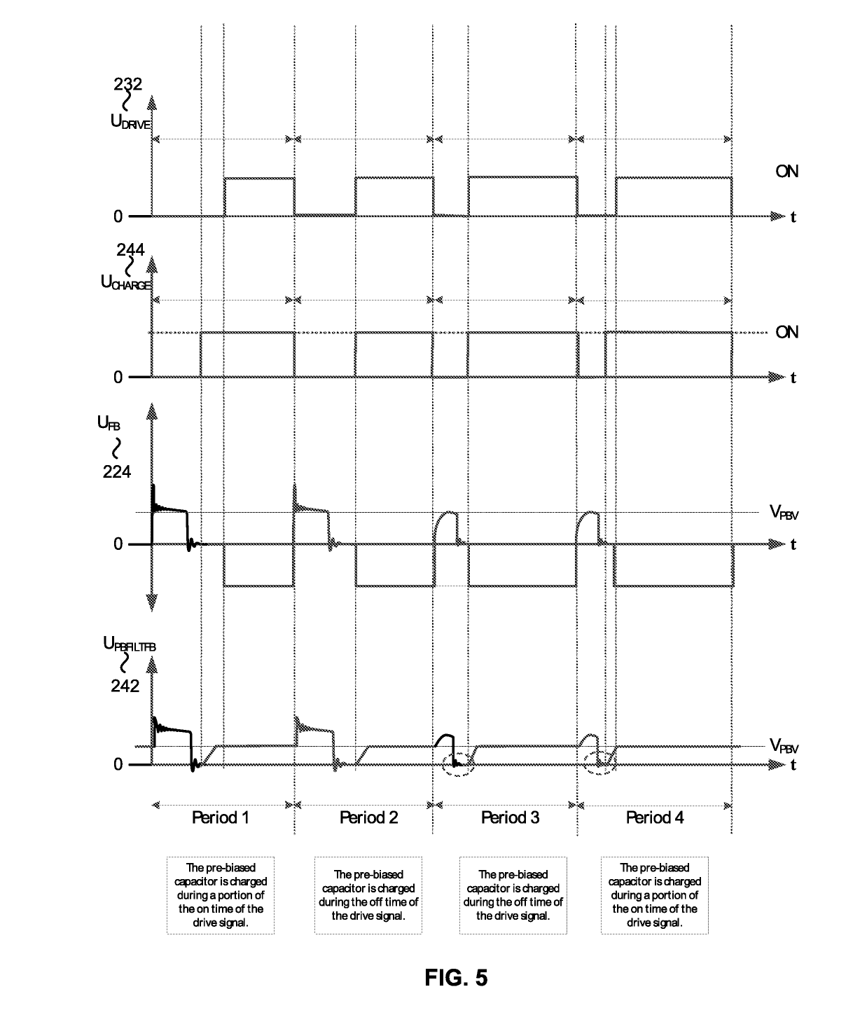

To illustrate, FIG. 5 shows example waveforms of drive signal U_{DRIVE} 232, charge signal U_{CHARGE} 244, feedback signal U_{FB} 224, and pre-biased filtered feedback signal U_{PBFILTFB} 242 during normal and light load conditions. In some examples, as illustrated by period 1, driver circuit 236 may configure charge signal U_{CHARGE} 244 to cause switch 412 to switch to an on state during at least a portion of the time that drive signal U_{DRIVE} 232 is low and at least a portion of the time that drive signal U_{DRIVE} 232 is high. During period 1 while a normal load condition is present, drive signal U_{DRIVE} 232 is at a low voltage (a voltage sufficient to cause power switch S1 210 to be in an off state) for the first portion of the period and at a high voltage (a voltage sufficient to cause power switch S1 210 to to be in an on state) for the second portion of the period. During a portion of the time that drive signal U_{DRIVE} 232 is at a low voltage, the feedback signal U_{FB} 224 includes an initial voltage spike and ripple as discussed above with respect to FIG. 1A. Once the energy is transferred to the output of the converter and the output diode stops conducting, the voltage of the feedback signal U_{FB} 224 drops to zero volts. During this time, charge signal U_{CHARGE} 244 is low, causing switch 412 to be in an off state, thereby uncoupling pre-biased voltage source 414 from pre-biased filter capacitor C_{PB} 402. Additionally, switch 410 is in an on state, thereby coupling feedback signal U_{FB} 224 to pre-biased filter capacitor C_{PB} 402. This allows feedback signal U_{FB} 224 to charge pre-biased filter capacitor C_{PB} 402, thereby causing a spike and ripple in the pre-biased filtered feedback signal U_{PBFILTFB} 242. After the feedback signal U_{FB} 224 drops to zero volts and before drive signal U_{DRIVE} 232 goes high, driver circuit 236 may drive charge signal U_{CHARGE} 244 to a high voltage level, causing switch 410 to be switched to an off state, thereby uncoupling feedback signal U_{FB} 224 from pre-biased filter capacitor C_{PB} 402. Additionally, switch 412 is switched to an on state, thereby coupling pre-biased voltage source 414 to buffer 406 and pre-biased filter capacitor C_{PB} 402. This allows pre-biased voltage source 414 to charge pre-biased filter capacitor C_{PB} 402 to the pre-bias voltage V_{PBV}, thereby causing pre-biased filtered feedback signal U_{PBFILTFB} 242 to gradually increase in voltage until reaching pre-bias voltage V_{PBV}. At the start of period 2, driver circuit 236 may drive charge signal U_{CHARGE} 244 low while drive signal U_{DRIVE} 232 goes low.

In other examples, as illustrated by period 2, driver circuit 236 may configure charge signal U_{CHARGE} 244 to cause switch 412 to switch to an on state at the same time or after drive signal U_{DRIVE} 232 goes high. During period 2 while a normal load condition is present, drive signal U_{DRIVE} 232 is at a low voltage (a voltage sufficient to cause power switch S1 210 to be in an off state) for the first portion of the period and at a high voltage (a voltage sufficient to cause power switch S1 210 to be in an on state) for the second portion of the period. During a portion of the time that drive signal U_{DRIVE} 232 is at a low voltage, the feedback signal U_{FB} 224 includes an initial voltage spike and ripple as discussed above with respect to FIG. 1A. Once the energy is transferred to the output of the converter and the output diode stops conducting, the voltage of the feedback signal U_{FB} 224 drops to zero volts. During this time, charge signal U_{CHARGE} 244 is low, causing switch 412 to be in an off state, thereby uncoupling pre-biased voltage source 414 from pre-biased filter capacitor C_{PB} 402. Additionally, switch 410 is in an on state, thereby coupling feedback signal U_{FB} 224 to pre-biased filter capacitor C_{PB} 402. This allows feedback signal U_{FB} 224 to charge pre-biased filter capacitor C_{PB} 402, thereby causing a spike and ripple in the pre-biased filtered feedback signal U_{PBFILTFB} 242. As the drive signal U_{DRIVE} 232 goes high, controller 422 may drive charge signal U_{CHARGE} 244 to a high voltage level, causing switch 410 to be switched to an off state, thereby uncoupling feedback signal U_{FB} 224 from pre-biased filter capacitor C_{PB} 402. Additionally, switch 412 is switched to an on state, thereby coupling pre-biased voltage source 414 to buffer 406 and pre-biased filter capacitor C_{PB} 402. This allows thereby pre-biased voltage source 414 to charge pre-biased filter capacitor C_{PB} 402 to the pre-bias voltage V_{PBV}, thereby causing pre-biased filtered feedback signal U_{PBFILTFB} 242 to gradually increase in voltage until reaching pre-bias voltage V_{PBV}. At the start of period 3, driver circuit 236 may drive charge signal U_{CHARGE} 244 low while drive signal U_{DRIVE} 232 is driven low.

Periods 3 and 4 illustrate examples of drive signal U_{DRIVE} 232, charge signal U_{CHARGE} 244, feedback signal U_{FB} 224, and pre-biased filtered feedback signal U_{PBFILTFB} 242 during a light load condition. In particular, period 3 illustrates an example in which driver circuit 236 may configure charge signal U_{CHARGE} 244 to cause switch 412 to switch to an on state at the same time or after drive signal U_{DRIVE} 232 goes high. In this example and as described above with respect to FIG. 1B, the feedback signal U_{FB} 224 may not include a voltage spike and ripple like that present during normal load conditions. However, the operation of charge signal U_{CHARGE} 244 is similar to that described above with respect to period 2 of FIG. 5.

In another example, period 4 illustrates an example in which driver circuit 236 may configure charge signal U_{CHARGE} 244 to cause switch 412 to switch to an on state after the feedback signal U_{FB} 224 drops to zero volts and before drive signal U_{DRIVE} 232 goes high. In this example and as described above with respect to FIG. 1B, the feedback signal U_{FB} 224 may not include a voltage spike and ripple like that present during normal load conditions. However, the operation of charge signal U_{CHARGE} 244 is similar to that described above with respect to period 1 of FIG. 5. In operation, controller 422 may configure charge signal 244 as described above with respect to any one or more of the periods 1-4.

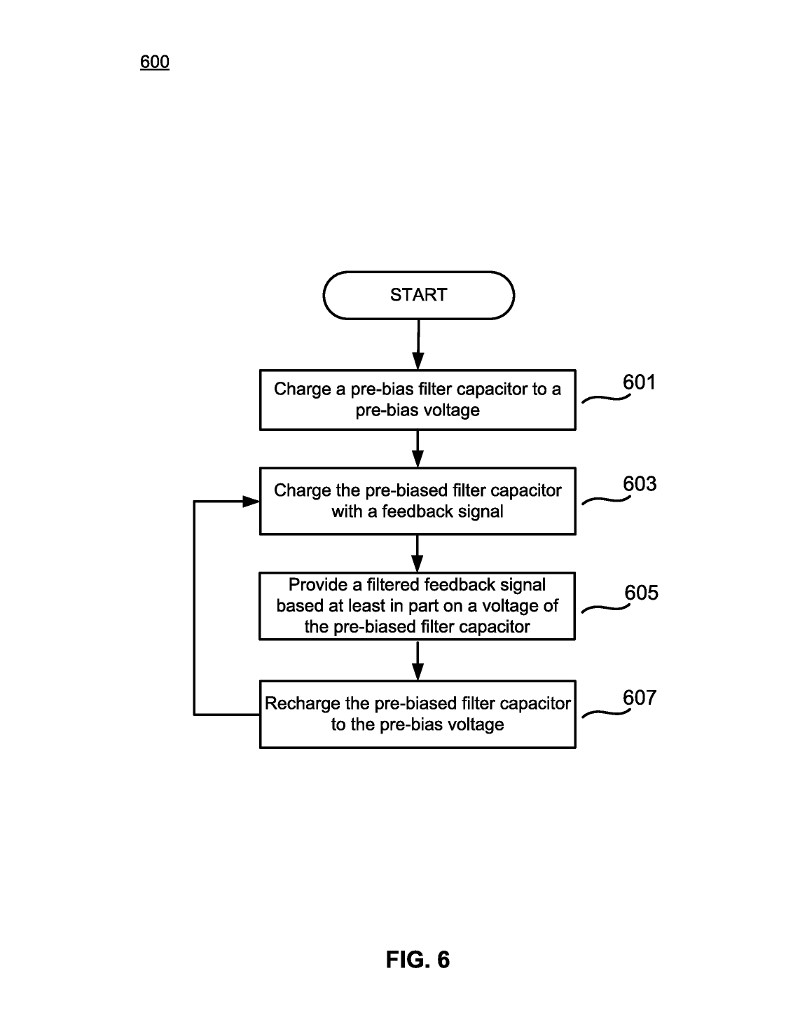

FIG. 6 illustrates an example process 600 for sampling a feedback signal using a pre-biased filter capacitor. At block 601, a pre-biased filter capacitor may be pre-charged to a pre-bias voltage. In some examples, a circuit similar or identical to pre-biased filter circuits 234 or 434 may be used to charge a pre-biased filter capacitor (e.g., pre-biased filter capacitor C_{PB} 402) using a voltage source (e.g., pre-biased voltage source 414) to charge the pre-biased filter capacitor to a pre-bias voltage (e.g., V_{PBV}), as discussed above with respect to FIGS. 4 and 5.

At block 603, the pre-biased filter capacitor may be charged using a feedback signal. In some examples, a circuit similar or identical to pre-biased filter circuits 234 or 434 may be used to charge a pre-biased filter capacitor (e.g., pre-biased filter capacitor C_{PB} 402) using a feedback signal (e.g., feedback signal U_{FB} 224) to charge the pre-biased filter capacitor, as discussed above with respect to FIGS. 4 and 5. Switching circuitry similar or identical to that described above with respect to FIG. 4 may be used to selectively couple the pre-biased filter capacitor to the voltage source and feedback signal at blocks 601 and 603.

At block 605, a filtered feedback signal may be provided to a driver circuit. In some examples, a circuit similar or identical to pre-biased filter circuits 234 or 434 may be used to provide a filtered feedback signal (e.g., pre-biased filtered feedback signal U_{PBFILTFB} 242) based at least in part on a voltage V_{PB} across pre-biased filter capacitor C_{PB} 402 to driver circuit 236 for use in output regulation.

At block 607, the pre-biased filter capacitor may be recharged to the pre-bias voltage. In some examples, as discussed above with respect to FIGS. 4 and 5, the pre-biased filter capacitor (e.g., pre-biased filter capacitor C_{PB} 402) may be recharged using a voltage source (e.g., pre-biased voltage source 414) to charge the pre-biased filter capacitor to the pre-bias voltage (e.g., V_{PBV}). In some examples, as discussed above with respect to periods 2 and 3 of FIG. 5, the pre-biased filter capacitor may begin recharging at the same time or after the drive signal U_{DRIVE} 232 goes low. In other examples, as discussed above with respect to periods 1 and 4 of FIG. 5, the pre-biased filter capacitor may begin recharging before the drive signal U_{DRIVE} 232 goes low.

The process may then return to block 603 where the pre-biased filter capacitor may again be charged by the feedback signal.

While the blocks of process 600 have been presented in a particular sequence, it should be appreciated that they may be performed in any order and that one or more blocks may be performed at the same time.

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention. Indeed, it is appreciated that the specific example voltages, currents, frequencies, power range values, times, etc., are provided for explanation purposes and that other values may also be employed in other embodiments and examples in accordance with the teachings of the present invention.

These modifications can be made to examples of the invention in light of the above detailed description. The terms used in the following claims should not be construed to limit the invention to the specific embodiments disclosed in the specification and the claims. Rather, the scope is to be determined entirely by the following claims, which are to be construed in accordance with established doctrines of claim interpretation. The present specification and figures are accordingly to be regarded as illustrative rather than restrictive.

What is claimed is:

1. A pre-biased filter circuit comprising:
a pre-biased filter capacitor;
a pre-bias voltage source for charging the pre-biased filter capacitor; and
switching circuitry coupled to the pre-biased filter capacitor and the pre-bias voltage source, wherein the switching circuitry is operable to couple the pre-biased filter capacitor to the pre-bias voltage source and a feedback signal representative of an output of a power converter.

2. The circuit of claim 1, wherein the switching circuitry comprises:
a first transistor coupled to the pre-bias voltage source, wherein the first transistor is operable to selectively couple the pre-biased filter capacitor to the pre-bias voltage source in response to a charge signal;
an inverter operable to invert the charge signal to generate an inverted charge signal; and
a second transistor operable to receive the feedback signal, wherein the second transistor is further operable to selectively couple the pre-biased filter capacitor to the feedback signal in response to the inverted charge signal.

3. The circuit of claim 2, wherein the switching circuitry further comprises a time-delay circuit coupled to the inverter and the second transistor.

4. The circuit of claim 1, wherein a pre-bias voltage of the pre-bias voltage source is less than a regulated voltage of the feedback signal.

5. The circuit of claim 1, wherein the pre-biased filter capacitor is coupled to provide a filtered feedback signal to a driver circuit in a controller for a switched mode power converter.

6. The circuit of claim 1, wherein the filtered feedback signal comprises a voltage of the pre-biased filter capacitor.

7. The circuit of claim 1, wherein the pre-biased filter circuit is included within a controller for a switched mode power converter.

8. The circuit of claim 7, wherein the controller further comprises a driver circuit coupled to the pre-biased filter circuit, wherein the driver circuit is operable to generate the charge signal and a drive signal to regulate an output of the power converter.

9. A method for providing a filtered feedback signal using a pre-biased filter capacitor, the method comprising:
pre-charging the pre-biased filter capacitor using a pre-bias voltage source;
charging the pre-biased filter capacitor using a feedback signal representative of an output of a power converter; and
providing a filtered feedback signal based at least in part on a voltage of the pre-biased filter capacitor.

10. The method of claim 9, wherein a voltage of the pre-bias voltage source is less than a regulated voltage of the feedback signal.

11. The method of claim 9, wherein after providing the filtered feedback signal, the method further comprises recharging the pre-biased filter capacitor using the pre-bias voltage source.

12. The method of claim 9, wherein the filtered feedback signal is provided to a driver circuit of a controller for a switched mode power converter.

13. The method of claim 9, wherein pre-charging the pre-biased filter capacitor using the pre-bias voltage source comprises coupling the pre-biased filter capacitor to the pre-bias voltage source.

14. The method of claim 9, wherein charging the pre-biased filter capacitor using the feedback signal comprises coupling the pre-biased filter capacitor to the feedback signal.

15. A power converter comprising:
an energy transfer element;
a switch coupled to the energy transfer element, wherein the switch and the energy transfer element are operable to conduct current during an on time of the switch; and
a controller coupled to provide a drive signal to control the switch to regulate an output of the power converter, wherein the controller comprises:
a driver circuit operable to generate the drive signal and a charge signal; and
a pre-biased filter circuit comprising:
a pre-biased filter capacitor;
a pre-bias voltage source for charging the pre-biased filter capacitor; and
switching circuitry coupled to the pre-biased filter capacitor and the pre-bias voltage source, wherein the switching circuitry is operable to couple the pre-biased filter capacitor to the pre-bias voltage source and a feedback signal representative of an output of the power converter.

16. The power converter of claim 15, wherein the switching circuitry comprises:
a first transistor coupled to the pre-bias voltage source, wherein the first transistor is operable to selectively couple the pre-biased filter capacitor to the pre-bias voltage source in response to the charge signal;
an inverter operable to invert the charge signal to generate an inverted charge signal; and
a second transistor operable to receive the feedback signal, wherein the second transistor is further operable to selectively couple the pre-biased filter capacitor to the feedback signal in response to the inverted charge signal.

17. The power converter of claim 15, wherein a pre-bias voltage of the pre-bias voltage source is less than a regulated voltage of the feedback signal.

18. The power converter of claim 15, wherein the pre-biased filter capacitor is coupled to provide a filtered feedback signal to the driver circuit.

19. The power converter of claim 18, wherein the filtered feedback signal comprises a voltage of the pre-biased filter capacitor.

20. The power converter of claim 15, wherein the driver circuit is operable to drive the charge signal to a high charge signal voltage when the drive signal is driven to a low drive signal voltage, and wherein the driver circuit is further operable to drive the charge signal to a low charge signal voltage when the drive signal is driven to a high drive signal voltage.

21. The power converter of claim 15, wherein the driver circuit is operable to drive the charge signal to a high charge signal voltage before the drive signal is driven to a low drive signal voltage, and wherein the driver circuit is further operable to drive the charge signal to a low charge signal voltage when the drive signal is driven to a high drive signal voltage.
